(19) United States
(12) Patent Application Publication
(10) Pub. No.: US 2023/0049583 A1
(43) Pub. Date: Feb. 16, 2023

(54) ELECTRONIC PARKING BRAKE SYSTEM AND CONTROL METHOD THEREFOR

(71) Applicant: MANDO CORPORATION, Pyeongtaek-si, Gyeonggi-do (KR)

(72) Inventor: Taewoong OH, Suwon-si, Gyeonggi-do (KR)

(73) Assignee: MANDO CORPORATION, Pyeongtaek-si, Gyeonggi-do (KR)

(21) Appl. No.: 17/784,363

(22) PCT Filed: Dec. 7, 2020
(86) PCT No.: PCT/KR2020/017761

§ 371 Date: Jun. 10, 2022

(30) Foreign Application Priority Data
Dec. 18, 2019 (KR) 10-2019-0169346

(51) Int. Cl. B60T 8/1755; B60T 7/12

(52) U.S. Cl. CPC B60T 8/17551; B60T 7/12; B60T 2201/06; B60Y 2400/81

(57) ABSTRACT

Disclosed herein an electric parking brake (EPB) system includes a first EPB provided on a left wheel of a vehicle; a second EPB provided on a right wheel of the vehicle; and a controller configured to determine an EPB that is to be operated alone from among the first and second EPBs in response to a gear being shifted to a P-stage, and operate the determined EPB alone.

### TECHNICAL FIELD

The disclosure relates to an electric parking brake (EPB) system using an electric parking brake to maintain a stopped state of a vehicle and a method of controlling the same.

### BACKGROUND ART

In general, EPB systems include an EPB having an electric motor and a controller for driving the EPB, and the controller generates a clamping force required for parking by driving the EPB. For example, the EPB systems generate a clamping force required for parking by increasing a torque generated from the electric motor through a reducer and by using the mechanical structure device inside a caliper.

A vehicle to which an electronic transmission system is applied, when a driver shifts to P-stage, replaces a function of the P-stage mechanical gear by applying the EPB since there is no P-stage mechanical gear.

However, since the EPB operates not only when parking is applied or released, but also when a driver shifts to P-stage, durability thereof may decrease due to an increase in the number of operations.

### DISCLOSURE

### Technical Problem

An aspect of the disclosure is to provide an EPB system capable of minimizing deterioration in durability of the EPB, and a method for controlling the same.

### Technical Solution

In accordance with an aspect of the disclosure, an electric parking brake (EPB) system includes a first EPB provided on a left wheel of a vehicle; a second EPB provided on a right wheel of the vehicle; and a controller configured to determine an EPB that is to be operated alone from among the first and second EPBs in response to a gear being shifted to a P-stage, and operate the determined EPB alone.

The controller may determine an EPB that is to be operated alone from among the first and second EPBs whenever the gear is shifted to the P-stage, and operate the determined EPB alone.

The controller may stop a previously operated EPB among the first and second EPBs, and operate a previously non-operated EPB.

The controller may, in response to that a driver shifts the gear to the P-stage, determine whether a gradient of the vehicle is lower than a predetermined angle and a driver's continuous driving intention exists, and determine the EPB that is to be operated alone from among the first and second EPBs in response to determining that the gradient of the vehicle is lower than the predetermined angle and the driver's continuous driving intention exists.

The controller may, when the determined EPB is operated alone, determine a clamping force required when the first and second EPBs are simultaneously operated for parking, and operate the determined EPB based on the determined clamping force.

The controller may determine whether a stand-alone operation release condition is satisfied during the determined EPB being operated alone, and in response to that the stand-alone operation release condition is satisfied, operate additionally an EPB that has not been operated.

The controller may determine that the stand-alone operation release condition is satisfied when at least one of that: a slip of vehicle occurs, an ignition switch is off, and an EPB switch is on is satisfied.

The controller may store identification information of the EPB operated alone in a memory.

In accordance with another aspect of the disclosure, an EPB system of a vehicle equipped with an electronic transmission system include a first EPB provided on a left wheel of the vehicle; a second EPB provided on a right wheel of the vehicle; and a controller configured to, when a gear of the electronic transmission system is shifted to the P-stage, determine whether a gradient of the vehicle is lower than a predetermined angle and a driver's continuous driving intention exists, and operate alone any one of the first and second EPBs in response to determining that the gradient of the vehicle is lower than the predetermined angle and the driver's continuous driving intention exists.

The controller may operate an EPB that is not operated alone among the first and second EPBs when shifting a previous P-stage.

In accordance with another aspect of the disclosure, a method of controlling an EPB system including a first EPB provided on a left wheel of a vehicle and a second EPB provided on a right wheel of the vehicle, the method includes determining an EPB that is to be operated alone from among the first and second EPBs in response to that a gear is shifted to a P-stage; and operating the determined EPB alone.

The determining an EPB that is to be operated alone may further include determining whether a gradient of the vehicle is lower than a predetermined angle and a driver's continuous driving intention exists, and determining the EPB that is to be operated alone from among the first and second EPBs in response to determining that the gradient of the vehicle is lower than the predetermined angle and the driver's continuous driving intention exists.

The determining an EPB that is to be operated alone may further include stopping a previously operated EPB among the first and second EPBs, and determining the EPB to be operated alone for operating a previously non-operated EPB.

The operating the determined EPB alone may further include determining a clamping force required for parking when simultaneously operating the first and second EPBs when the determined EPB is operated alone, and operating the determined EPB based on the determined clamping force.

The method may further include operating additionally an EPB that has not been operated when at least one of that: a slip of vehicle occurs, an ignition switch is off, and an EPB switch is on is satisfied during the operating the determined EPB alone.

### Advantageous Effects

An embodiment of the disclosure may minimize deterioration in durability of the EPB.

### DESCRIPTION OF DRAWINGS

FIG. 1 shows a vehicle to which an EPB system is applied according to an embodiment of the disclosure.

FIG. 2 shows a configuration of an EPB applied to the EPB system according to an embodiment of the disclosure.

FIG. 3 shows a control block of an EPB system according to an embodiment of the disclosure.

FIG. 4 shows determination of an appropriate gradient in an EPB system according to an embodiment of the disclosure.

FIG. 5 shows determination of a driver's continuous driving intention in an EPB system according to an embodiment of the disclosure.

FIG. 6 shows that an EPB system according to an embodiment of the disclosure is provided on left and right rear wheels of a vehicle.

FIG. 7 shows that an EPB according to an embodiment of the disclosure generates a clamping force only on the left wheel among rear wheels of the vehicle.

FIG. 8 shows that an EPB according to an embodiment of the disclosure generates a clamping force only on the right wheel among rear wheels of the vehicle.

FIG. 9 shows a control method of an EPB system according to an embodiment of the disclosure.

FIG. 10 shows switching an EPB stand-alone operation to the left and right EPBs simultaneous operation in an EPB system according to an embodiment of the disclosure.

### MODES OF THE INVENTION

Like numerals refer to like elements throughout the specification. Not all elements of embodiments of the disclosure will be described, and description of what are commonly known in the art or what overlap each other in the embodiments will be omitted.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Further, when it is stated that a member is “on” another member, the member may be directly on the other member or a third member may be disposed therebetween.

Terms such as “˜unit”, “˜group”, “˜block”, “˜member”, and “˜module” used in the specification may be implemented in software or hardware. Terms such as “˜unit”, “˜group”, “˜block”, “˜member”, and “˜module” may refer to a unit that processes at least one function or operation. In addition, terms such as “˜unit”, “˜group”, “˜block”, “˜member”, and “˜module” are used in at least one piece of hardware such as a field-programmable gate array (FPGA)/application specific integrated circuit (ASIC), or at least one software or processor stored in a memory.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, operating principles and embodiments of the disclosure will be described with reference to the accompanying drawings.

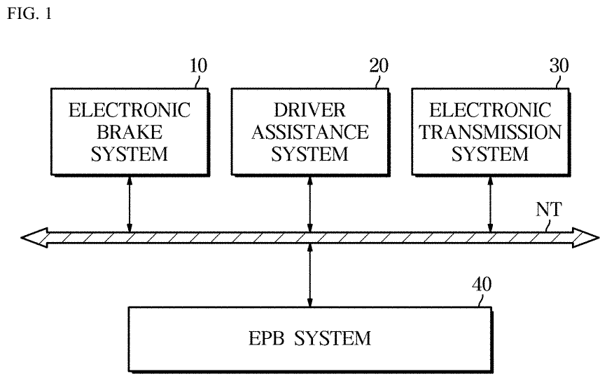

FIG. 1 shows a vehicle to which an electric parking brake (EPB) system according to an exemplary embodiment is applied.

Referring to FIG. 1, a vehicle may include an electronic brake system 10, a driver assistance system 20, an electronic transmission system 30, and an EPB system 40.

The electronic brake system 10 may control a braking device in response to a driver's intention to brake through a brake pedal and/or slip of wheels of the vehicle.

The electronic brake system 10 may be an anti-lock braking system (ABS) capable of temporarily releasing braking of the wheels in response to the slip of the wheels detected when the vehicle is braked. Furthermore, the electronic brake system 10 may be an electronic stability control (ESC) device capable of selectively releasing braking of the wheels in response to oversteering and/or understeering detected when steering the vehicle. Furthermore, the electronic brake system 10 may be a traction control system (TCS) capable of temporarily braking the wheels in response to the slip of the wheels detected when the vehicle is driven.

The driver assistance system 20 may determine, when a pedestrian and/or an obstacle exists in a detection area depending on a gear state among a front detection area and a rear detection area of the vehicle when the vehicle starts after stopping, whether an emergency braking of the vehicle is required according to the driver's intention to accelerate, and warn a driver or perform the emergency braking of the vehicle according to the determination result.

The driver assistance system 20 may be implemented as Forward Collision Avoidance (FCA), Autonomous Emergency Brake (AEB), Lane Departure Warning (LDW), Lane Keeping Assist (LKA), Smart Parking Assist System (SPAS), Driver Attention Warning (DAW), Smart Cruise Control (SCC), and Blind Spot Detection (BSD), and the like.

The electronic transmission system 30 is a shifting system that switches driving functions by transmitting an electrical signal to a transmission when a driver presses a button or lightly pushes and pulls an electronic lever for convenience of shifting.

The EPB system 40 may communicate with the electronic brake system 10, the driver assistance system 20, and the electronic transmission system 30 through a vehicle communication network (NT). For example, systems may exchange data through Ethernet, Media Oriented Systems Transport (MOST), Flexray, Controller Area Network (CAN), and Local Interconnect Network (LIN), and the like.

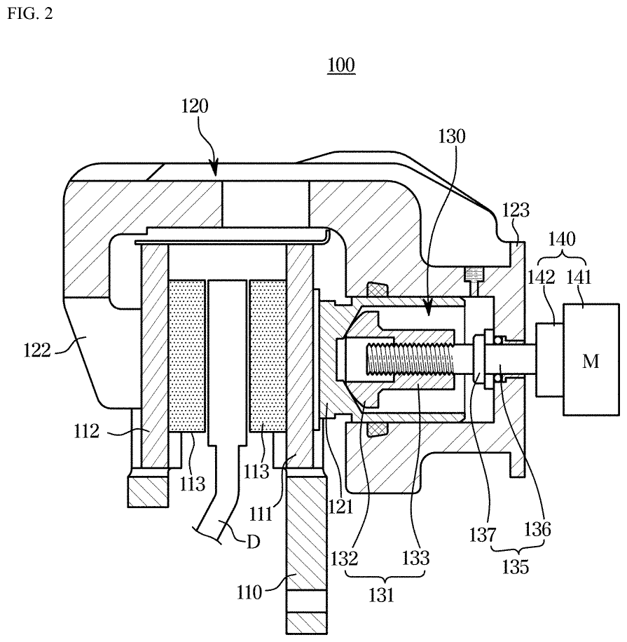

FIG. 2 shows a configuration of an EPB applied to the EPB system according to an embodiment of the disclosure.

Referring to FIG. 2, an EPB 100 includes a carrier 110 on which a pair of pad plates 111 and 112 are installed to move forward and backward to press a brake disc D rotating together with wheels of the vehicle, a caliper housing 120 slidably installed on the carrier 110 and provided with a cylinder 123 installed so that a piston 121 may move forward and backward by a braking hydraulic pressure, a power transmission unit 130 that presses the piston 121, and a motor actuator 140 that transmits a rotational force to the power transmission unit 130 by using a motor M.

The pair of pad plates 111 and 112 may include an inner pad plate 111 disposed in contact with the piston 121 and an outer pad plate 112 disposed in contact with the finger part 122 of the caliper housing 120. The pair of pad plates 111 and 112 are installed on the carrier 110 fixed to a vehicle body so as to move forward and backward toward opposite sides of the brake disk D. Furthermore, a brake pad 113 is attached to one surface of each of the pad plates 111 and 112 facing the brake disk D.

The caliper housing 120 is slidably installed on the carrier 110. More specifically, the caliper housing 120 includes the cylinder 123 in which the power transmission unit 130 is installed on a rear portion thereof and the piston 121 is embedded so as to advance and retreat, and the finger part 122 bent down to operate the outer pad plate 112 on a front portion thereof. The finger part 122 and the cylinder 123 are integrally formed.

The piston 121 is provided in a cylindrical shape with a cup-shaped thereinside and is slidably inserted in the cylinder 123. The piston 121 presses the inner pad plate 111 toward the brake disk D by an axial force of the power transmission unit 130 receiving a rotational force of the motor actuator 140. Accordingly, when the axial force of the power transmission unit 130 is applied, the piston 121 advances toward the inner pad plate 111 to press the inner pad plate 111, and in turn the caliper housing 120 operates in a opposite direction to the piston 121 by a reaction force such that the finger part 122 presses the outer pad plate 112 toward the brake disc 100, thereby performing braking operation.

The power transmission unit 130 may serve to receive the rotational force from the motor actuator 140 to press the piston 121 toward the inner pad plate 111.

The power transmission unit 130 may include a nut member 131 that is installed to be disposed in the piston 121 and is in contact with the piston 121, and a spindle member 135 screw-coupled to the nut member 131..

The nut member 131 may be disposed inside the piston 121 in a state in which rotation thereof is restricted, and may be screw-coupled to the spindle member 135.

The nut member 131 may include a head portion 132 provided to be in contact with the piston 121, and a coupling portion 133 extending from the head portion 132 and having a female thread on an inner circumferential surface so as to be screw-coupled with the spindle member 135.

The nut member 131 moves in a forward direction or a reverse direction according to a rotational direction of the spindle member 135 and may serve to press and release the piston 121. In this case, the forward direction may be a movement direction in which the nut member 131 approaches the piston 121. The backward direction may be a movement direction in which the nut member 131 moves away from the piston 121. Furthermore, the forward direction may be a movement direction in which the piston 121 approaches the brake pad 113. The backward direction may be a movement direction in which the piston 121 moves away from the brake pad 113.

The spindle member 135 may include a shaft portion 136 that passes through the rear portion of the caliper housing 120 and rotates by receiving the rotational force of the motor actuator 140, and a flange portion 137 extending radially from the shaft portion 136. One side of the shaft portion 131 may be rotatably installed through a rear side of the cylinder 123, and the other side thereof may be disposed inside the piston 121. At this time, the one side of the shaft portion 131 passing through the cylinder 123 is connected to an output shaft of a reducer 142 to receive the rotational force of the motor actuator 140.

The motor actuator 140 may include an electric motor 141 and the reducer 142.

The electric motor 141 may press or release the pressure of the piston 121 by rotating the spindle member 135 to move the nut member 131 forward and backward.

The reducer 142 may be provided between an output side of the electric motor 141 and the spindle member 135.

By the above configuration, the EPB may move the nut member 131 by rotating the spindle member 135 in one direction using the motor actuator 140 during a parking operation, thereby pressing the piston 121. The piston 121 pressed by the movement of the nut member 131 presses the inner pad plate 111 to bring the brake pad 113 into close contact with the brake disc D, thereby generating a clamping force.

Furthermore, the EPB rotates the spindle member 135 in the opposite direction using the motor actuator 140 during a parking release operation, so that the nut member 131 pressed by the piston 121 moves backward. In other words, the pressure on the piston 121 may be released by the retreat movement of the nut member 131, which causes the clamping force generated by the brake pad 113 being spaced apart from the brake disc M to be released.

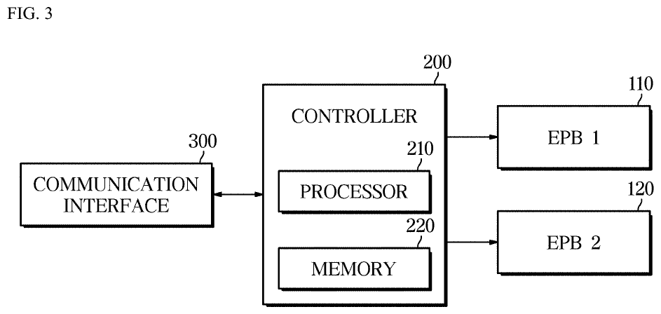

FIG. 3 shows a control block of the EPB system according to an embodiment of the disclosure.

Referring to FIG. 3, the EPB system 30 may include a controller 200 that performs overall control related to operations of the EPBs 110 and 120.

A communication interface 300 may be electrically connected to input/output sides of the controller 200.

A first EPB 110 and a second EPB 120 may be electrically connected to the output side of the controller 200.

The communication interface 300 may transmit and receive communication signals to and from the electronic brake system 10, the driver assistance system 20, and the electronic transmission system 30 through the NT. The communication interface 310 may include a CAN transceiver.

The controller 200 may be referred to as an Electronic Control Unit (ECU).

The controller 200 may include a processor 210 and a memory 220.

The memory 200 may store a program for processing or controlling the processor 210 and various data for the operation of the EPB system.

The memory 220 may include not only volatile memories such as Static Random Access Memory (S-RAM) and Dynamic Random Access Memory (D-RAM), but also non-volatile memories such as flash memory, read only memory (ROM), erasable programmable read only memory (EPROM), and the like.

The processor 210 may control the overall operation of the EPB system 40.

The controller 200 including the above configurations may drive the electric motor of each EPB. The controller 200 may forward or reverse the electric motor of each EPB through a motor driving circuit that drives the electric motor of each EPB.

The controller 200 may perform a parking operation mode or a parking release mode according to an operation signal of the EPB switch operated by a driver or an operation signal generated by a program related to the operation of the EPB.

The controller 200 moves the nut member 131 forward to press the piston 121 by rotating the electric motor 141 in one direction in the parking operation mode, which causes the brake pad 113 to come into close contact with the brake disc D, thereby performing the parking operation (also referred to as Parking Apply) that generates the clamping force.

The controller 200 moves the nut member 131 backward to release the pressure of the piston 121 by rotating the electric motor 141 in the opposite direction in the parking release mode, which causes the brake pad 113 in close contact with the brake disc M to release from the brake disc, thereby performing the parking release operation (also referred to as Parking Release) that releases the generated clamping force.

The first and second EPBs 110 and 120 may be provided on left and right rear wheels of the vehicle, may be provided on left and right front wheels of the vehicle, and may be provided on the left and right rear wheels and left and right front wheels of the vehicle, respectively.

In the case of replacing stop function by engaging the EPB when the vehicle is stopped, the EPB system according to an embodiment of the disclosure may adapt a method of independently engaging the left and right EPBs alternately instead of the conventional method of simultaneously engaging the left and right EPBs in order to minimize deterioration of product durability due to the increased number of EPB operations compared to the conventional method.

In response to that a gear is shifted to the P-stage, the controller 200 may determine any one EPB that is to be operated (Apply) alone from among the first and second EPBs 110 and 120, and operate the determined EPB alone.

The controller 200 may request the electronic brake system 10, the driver assistance system 20, or/and the electronic transmission system 30 through the communication interface 300 and receive information required for controlling stand-alone operation of the EPB (or the EPB stand-alone operation) such as gear shift information, longitudinal acceleration information of the vehicle, and the like. For reference, if the controller 200 is a system capable of providing information required for controlling stand-alone operation of the EPB, the controller 200 may receive information from the system instead of the electronic brake system 10, the driver assistance system 20, and the electronic transmission system 30.

In response to that a driver shifts to the P-stage, the controller 200 determines whether a gradient of the vehicle is lower than a predetermined angle and a driver's continuous driving intention exists, and determine the EPB that is to be operated alone from among the first and second EPBs 110 and 120 in response to that the gradient of the vehicle is lower than the predetermined angle and the driver's continuous driving intention exists.

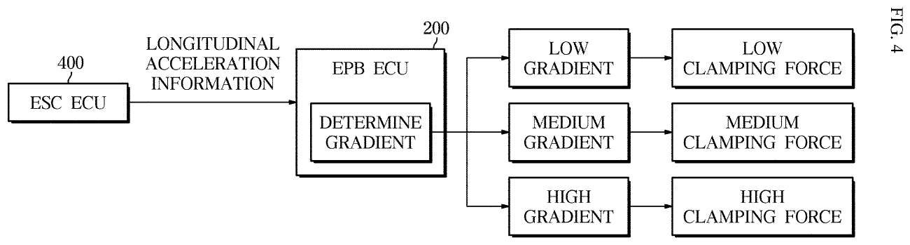

FIG. 4 is a view illustrating determination of an appropriate gradient in the EPB system according to an embodiment of the disclosure.

Referring to FIG. 4, the EPB system 40 may receive longitudinal acceleration information of the vehicle from the ESC system.

An ESC ECU 400 of the ESC system may transmit the longitudinal acceleration information detected by the longitudinal acceleration sensor installed in the vehicle to an EPB ECU, which is the controller 200.

The EPB ECU 200 may determine the gradient of the vehicle based on the received longitudinal acceleration information.

The EPB ECU 200 may determine whether a current gradient is an appropriate gradient based on the determined gradient.

The EPB ECU 200 may calculate a clamping force required for parking based on the determined gradient. For example, the EPB ECU 200 may calculate the clamping force to have a higher value as the gradient is higher.

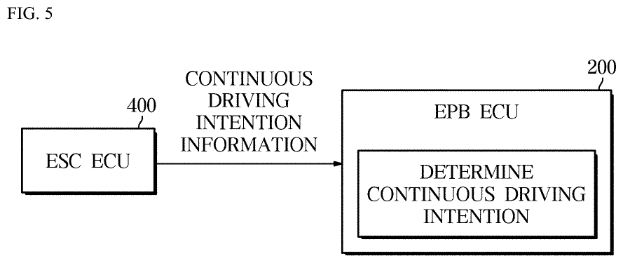

FIG. 5 is a view illustrating determination of a driver's continuous driving intention in the EPB system according to an embodiment of the disclosure.

Referring to FIG. 5, the EPB ECU 200 may receive continuous driving intention information from the ESC ECU 400 and determine whether the driver has the continuous driving intention. The continuous driving intention information may be information for determining temporarily stopped, that is, determining whether a driving intention after stopping presents.

For example, the ESC ECU 400 determines the driver's continuous driving intention by using a signal defined in VDA305-100, which defines a design range and a signal between the ESC ECU 400 and the EPB ECU 200, and transmit the determination to the EPB ECU 200.

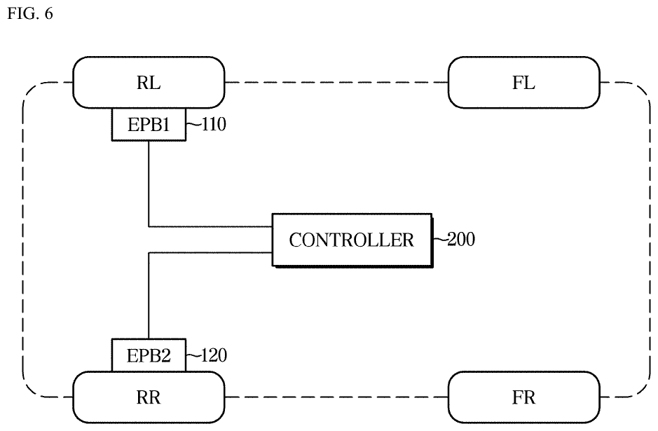

FIG. 6 shows that the EPB system according to an embodiment of the disclosure is provided on left and right rear wheels of the vehicle.

The first EPB 110 may be provided on the left rear (RL) wheel. The first EPB 110 may generate the clamping force required for parking of the RL wheel according to a control signal of the controller 200.

The second EPB 120 may be provided on the right rear (RR) wheel. The second EPB 120 may generate the clamping force required for parking to the RR wheel according to a control signal of the controller 200.

For reference, in the EPB system according to an embodiment of the disclosure, for convenience of description, it is described that each EPB is provided on the RL and RR wheels, but the present disclosure is not limited thereto. Each EPB may be provided on the left front (FL) wheel and the right front (FR) wheel, or may be provided on the front wheels and the rear wheels, respectively.

The controller 200 may determine any one EPB that is to be operated alone from among the first and second EPBs 110 and 120 on left and right whenever the gear is shifted to the P-stage, and operate the determined EPB alone. In this case, the controller 200 may stop the previously operated EPB among the first and second EPBs 110 and 120, and operate the other EPB that has not been previously operated.

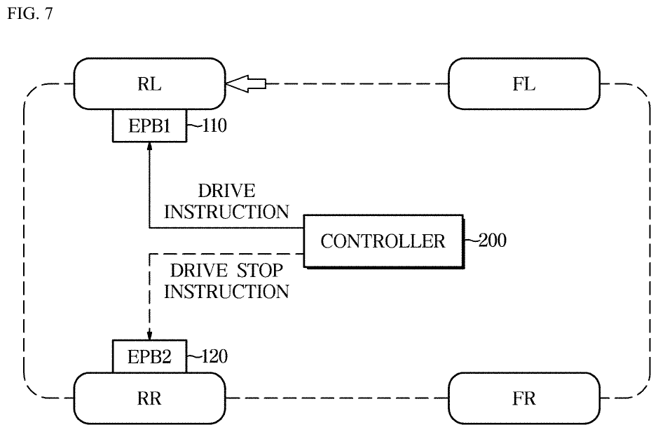

FIG. 7 shows that the EPB system according to an embodiment of the disclosure generates the clamping force only on the left wheel of rear wheels of the vehicle.

Referring to FIG. 7, in a state in which the gear of the vehicle is currently shifted to the P-stage, in response to that the gradient of the vehicle is the appropriate gradient and the driver's continuous driving intention exists, the controller 200 may operate the EPB that has not been previously operated alone.

When the second EPB 120 is previously operated alone, the controller 200, at present, may transmit a drive instruction to the first EPB 110 to operate the first EPB 110 and at the same time transmit a drive stop instruction to the second EPB 120 to stop the second EPB 120. In other words, the controller 200 may operate the first EPB 110 alone.

Accordingly, since the first EPB 110 provided on the RL wheel among the RL and RR wheels is operated alone, the controller 200 may generate the clamping force required for parking only for the RL wheel as indicated by an arrow.

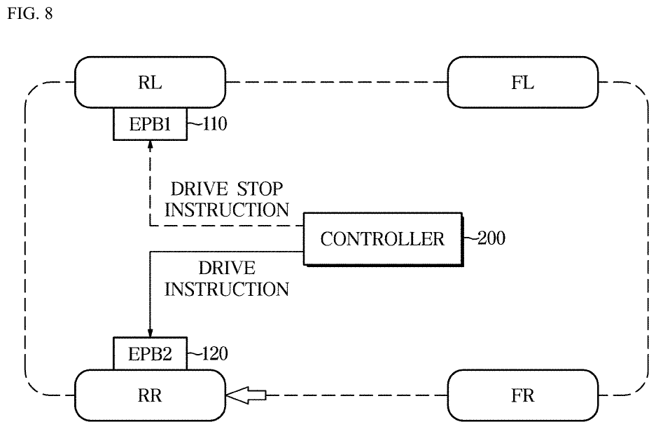

FIG. 8 shows that the EPB system according to an embodiment of the disclosure generates the clamping force only on the right wheel of rear wheels of the vehicle.

Referring to FIG. 8, in a state in which the gear of the vehicle is shifted to the P-stage at a next stop, in response to that the gradient of the vehicle is the appropriate gradient and the driver's continuous driving intention exists, the controller 200 may operate the second EPB 120 that has not been previously operated alone.

To this end, the controller 200 may transmit a drive instruction to the second EPB 120 that has not been operated during the previous stop to operate the second EPB 120 and at the same time transmit the drive stop instruction to the first EPB 110 that has been operated during the previous stop to stop the first The EPB 110. In other words, the controller 200 may operate the second EPB 120 alone.

Accordingly, since the second EPB 120 provided on the RR wheel among the RL and RR wheels is operated alone, the controller 200 may generate the clamping force required for parking only for the RR wheel as indicated by the arrow.

As described above, in the prior art, when the gear is shifted to the P-stage, the first and second EPBs 110 and 120 on left and right are simultaneously operated so as to stop the vehicle, so the number of operations of each EPB increases to reduce durability. However, in the exemplary embodiment, since only any one EPB of the first and second EPBs 110 and 120 is operated alone, the number of operations of the EPB may be reduced, thereby minimizing deterioration in durability.

On the other hand, in the case of the determined EPB being operated alone, the controller 200 may determine the clamping force required when the first EPB 110 and the second EPB 120 are simultaneously operated for parking, and operate the determined EPB alone based on the determined clamping force.

Even if only one of the left and right EPBs is operated alone, the controller 200 may increase the clamping force required for the operation of the EPB alone so as to secure the entire clamping force when the left and right EPBs are simultaneously operated.

The controller 200 may determine whether the determined EPB satisfies a stand-alone operation release condition during the stand-alone operation, and in response to that the stand-alone operation release condition is satisfied, operate additionally the non-actuated EPB.

The controller 200 may determine that the stand-alone operation release condition is satisfied in response to that at least one of that a slip(backward moving) of vehicle occurs, ignition switch is off, and the EPB switch is on is satisfied.

In response to that a vehicle speed remains higher than a predetermined speed during the operation of the EPB alone for more than a predetermined time or wheel pulse signals of the vehicle generates more than 1 pulse per second to sustain for more than a certain period of time, the controller 200 may determine that the slip of vehicle occurs.

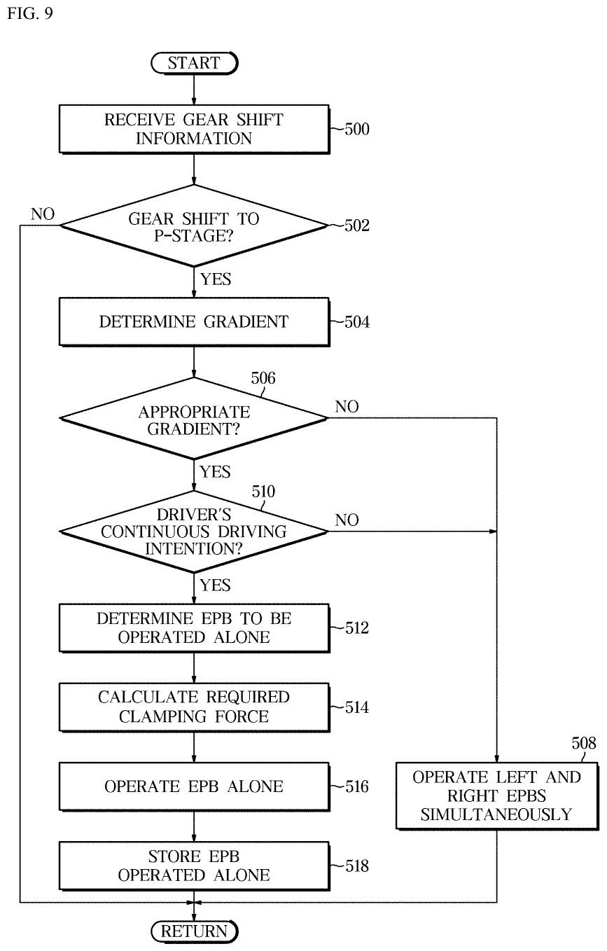

FIG. 9 shows a control method of the EPB system according to an embodiment of the disclosure.

Referring to FIG. 9, first, the controller 200 may receive gear shift information from any other system in the vehicle (500).

The controller 200 may determine whether the gear is shifted to the P-stage (502).

In response to determining that the gear is shifted to the P-stage according to the determination result in operation 502, the controller 200 may receive the longitudinal acceleration information of the vehicle from any other system in the vehicle to determine the gradient of the vehicle (504).

The controller 200 may determine whether the determined gradient of the vehicle is the appropriate gradient (506).

In response to determining that the gradient of the vehicle is not the appropriate gradient according to the determination result in operation 506, the controller 200 operates the left and right EPBs 110 and 120 simultaneously so as to secure sufficient clamping force required for parking (508).

Meanwhile, in response to determining that the gradient of the vehicle is the appropriate gradient according to the determination result in operation 506, the controller 200 may determine whether the driver's continuous driving intention exists (510).

In response to determining that the driver's continuous driving intention does not exist according to the determination result in operation 510, the controller 200 may operate the left and right EPBs 110 and 120 simultaneously to secure sufficient clamping force required for parking (508).

Meanwhile, in response to determining that the driver's continuous driving intention exists according to the determination result in operation 510, the controller 200 may determine the EPB that is to be operated alone (512). In the case of that the first EPB 110 is operated alone during the previous stop, the controller 200 may determine the EPB that is to be operated alone during the present stop as the second EPB 120.

The controller 200 may calculate the clamping force required for parking (514). Even if only one of the left and right EPBs is operated alone, the controller 200 may calculate the clamping force required for parking as a value increased from the clamping force required for the operation of the EPB alone so as to secure the entire clamping force when the left and right EPBs are simultaneously operated.

The controller 200 may operate the determined EPB alone (516).

The controller 200 may store which EPB among the left and right EPBs is operated alone in the memory (518). Identification information of the EPB stand-alone operated may be recorded in the memory.

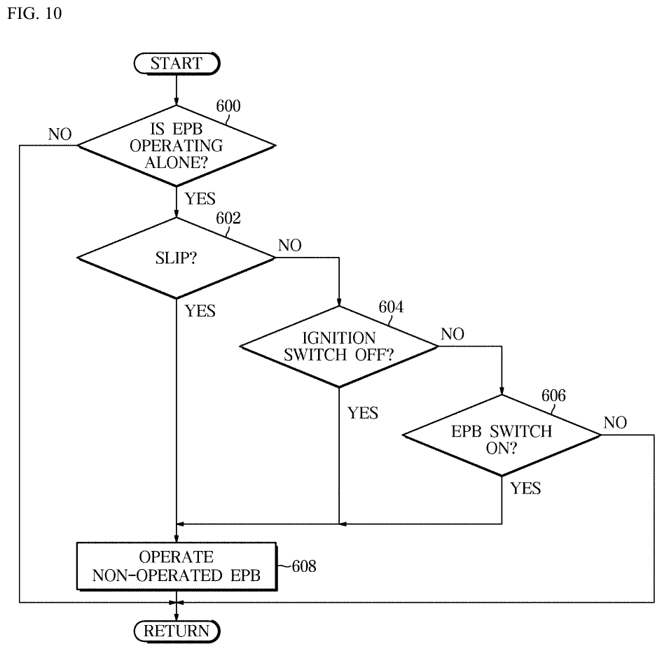

FIG. 10 shows switching the EPB stand-alone operation to the left and right EPBs simultaneous operation in the EPB system according to an embodiment of the disclosure.

Referring to FIG. 10, the controller 200 may determine whether the EPB that is operating alone is on (600).

In response to that the EPB is operating alone according to the determination result in operation 600, the controller 200 may determine whether the slip of vehicle occurs (602), the ignition switch is off (604), or the EPB switch is on (606).

In response to that at least one of the vehicle's slip occurrence, the ignition switch off, and the EPB switch on is satisfied, the controller 200 may operate the non-operated EPB (608). In other words, if the vehicle slips due to lack of braking force after EPB is engaged, the driver shows his/her intention to park by turning off the ignition, or the driver shows his/her intention to additionally engage by operating the EPB switch in an engaging direction, the non-operated EPB may be engaged.

As described above, the vehicle to which the electronic transmission system is applied does not have the P-stage mechanical gear. Such vehicles replace the function of the P-stage mechanical gear by engaging the EPB when shifting the P-stage gear. Conventionally, the more the number of operations of the EPB increases, the less durability reduces. However, the EPB system according to an embodiment of the disclosure, when a specific stopping condition is satisfied, applies a method of engaging the left and right EPBs alternately instead of simultaneously engaging the conventional left and right EPBs, thereby minimizing the deterioration of the durability of the brake.

The controller 200 and the communication interface 300 of the disclosure may be implemented as software modules. The controller 200 and the communication interface 300 may be mounted in the form of software in the ESC ECU 400 of the ESC system. When at least one of the controller 200 and the communication interface 300 is implemented as the software modules, the software modules may be stored in a computer-readable non-transitory computer readable media. Furthermore, at least one software module may be provided by an operating system (OS) or a certain application. Furthermore, a part of the at least one software module may be provided by the OS, and part of remaining may be provided by the certain application.

The disclosure may be embodied as computer-readable code on a medium in which a program is recorded. The computer-readable media may include any type of recording device in which data readable by a computer system is stored. Examples of computer-readable media include Hard Disk Drive (HDD), Solid State Disk (SSD), Silicon Disk Drive (SDD), ROM, RAM, CD-ROM, magnetic tape, floppy disk, and optical data storage device, and the like.

1. An electric parking brake (EPB) system, comprising:
a first EPB provided on a left wheel of a vehicle;
a second EPB provided on a right wheel of the vehicle; and
a controller configured to:
determine an EPB that is to be operated alone from among the first and second EPBs in response to a gear being shifted to a P-stage, and operate the determined EPB alone.

2. The electric parking brake system of claim 1, wherein the controller is configured to determine an EPB that is to be operated alone from among the first and second EPBs whenever the gear is shifted to the P-stage, and operate the determined EPB alone.

3. The electric parking brake system of claim 1, wherein the controller is configured to stop a previously operated EPB among the first and second EPBs, and operate a previously non-operated EPB.

4. The electric parking brake system of claim 1, wherein the controller is configured to, in response to that a driver shifts the gear to the P-stage, determine whether a gradient of the vehicle is lower than a predetermined angle and a driver's continuous driving intention exists, and determine the EPB that is to be operated alone from among the first and second EPBs in response to determining that the gradient of the vehicle is lower than the predetermined angle and the driver's continuous driving intention exists.

5. The electric parking brake system of claim 1, wherein the controller is configured to, when the determined EPB is operated alone, determine a clamping force required when the first and second EPBs are simultaneously operated for parking, and operate the determined EPB based on the determined clamping force.

6. The electric parking brake system of claim 1, wherein the controller is configured to determine whether a stand-alone operation release condition is satisfied during the determined EPB being operated alone, and in response to that the stand-alone operation release condition is satisfied, operate additionally an EPB that has not been operated.

7. The electric parking brake system of claim 6, wherein the controller is configured to determine that the stand-alone operation release condition is satisfied when at least one of that: a slip of vehicle occurs, an ignition switch is off, and an EPB switch is on is satisfied.

8. The electric parking brake system of claim 1, wherein the controller is configured to store identification information of the EPB operated alone in a memory.

9. An electric parking brake (EPB) system of a vehicle equipped with an electronic transmission system, comprising:
a first EPB provided on a left wheel of the vehicle;
a second EPB provided on a right wheel of the vehicle; and
a controller configured to:
when a gear of the electronic transmission system is shifted to a P-stage, determine whether a gradient of the vehicle is lower than a predetermined angle and a driver's continuous driving intention exists, and operate alone any one of the first and second EPBs in response to determining that the gradient of the vehicle is lower than the predetermined angle and the driver's continuous driving intention exists.

10. The electric parking brake system of claim 9, wherein the controller is configured to operate an EPB that is not operated alone among the first and second EPBs when shifting the previous P-stage.

11. A method of controlling an electric parking brake (EPB) system, the EPB system comprising a first EPB provided on a left wheel of a vehicle and a second EPB provided on a right wheel of the vehicle, the method comprising:
determining an EPB that is to be operated alone from among the first and second EPBs in response to that a gear is shifted to a P-stage; and
operating the determined EPB alone.

12. The method of claim 11, wherein determining an EPB that is to be operated alone further comprises:
determining whether a gradient of the vehicle is lower than a predetermined angle and a driver's continuous driving intention exists, and
determining the EPB that is to be operated alone from among the first and second EPBs in response to determining that the gradient of the vehicle is lower than the predetermined angle and the driver's continuous driving intention exists.

13. The method of claim 11, wherein determining an EPB that is to be operated alone further comprises stopping a previously operated EPB among the first and second EPBs, and determining the EPB to be operated alone for operating an previously non-operated EPB.

14. The method of claim 11, wherein operating the determined EPB alone may comprises determining a clamping force required for parking when simultaneously operating the first and second EPBs when the determined EPB is operated alone, and operating the determined EPB based on the determined clamping force.

15. The method of claim 11, further comprises operating additionally an EPB that has not been operated when at least one of that: a slip of vehicle occurs, an ignition switch is off, and an EPB switch is on is satisfied during the operating the determined EPB alone.
